(19) United States
(12) Patent Application Publication
(10) Pub. No.: US 2013/0181148 A1
(43) Pub. Date: Jul. 18, 2013

(54) AIR-OPERATED VALVE

(71) Applicants: Ichiro Tokuda, Osaka-shi (JP); Tsutomu Shinohara, Osaka-shi (JP)

(72) Inventors: Ichiro Tokuda, Osaka-shi (JP); Tsutomu Shinohara, Osaka-shi (JP)

(73) Assignee: FUJIKIN INCORPORATED, Osaka-shi (JP)

(21) Appl. No.: 13/812,268

(22) PCT Filed: May 20, 2011
(86) PCT No.: PCT/JP2011/061648

§ 371 Date: Mar. 26, 2013

(30) Foreign Application Priority Data
Jul. 27, 2010 (JP) 2010-168031

(51) Int. Cl. F16K 31/122

(52) U.S. Cl. CPC F16K 31/1221
USPC 251/63.6

(57) ABSTRACT

The present invention is directed to provide an air-operated valve suitable for use in a form using a one-touch joint. A casing 4 is made by an upper casing 22 and a lower casing 21 which are screwed in each other. Piston driving means 12 has a one-touch joint 15 attached to a top part of the upper casing 22.

### TECHNICAL FIELD

The present invention relates to an air-operated valve which opens/closes a fluid passage by driving a piston by the pressure of operation air.

### BACKGROUND ART

There is a well-known air-operated valve having a body provided with a fluid passage, a casing provided above the body, a valve member which opens/closes the fluid passage, a valve rod which moves upward/downward to move the valve member in an open/close direction, a piston provided for the valve rod, and piston driving means which drives the piston (for example, Patent Document 1).

### PRIOR ART DOCUMENT

### Patent Document

Patent Document 1: Japanese Unexamined Patent Application Publication No. 2008-144819

### SUMMARY OF THE INVENTION

### Problems to be Solved by the Invention

There is a case that an air-operated valve of this kind needs use of a one-touch joint. In this case, it is necessary to use an air-operated valve having a shape to which a one-touch joint can be connected and connect a one-touch joint to the air-operated valve. There is a problem that it is troublesome to change the air-operated valve without a one-touch joint to the air-operated valve with a one-touch joint.

An object of the present invention is to provide an air-operated valve suitable for use in a form of using a one-touch joint.

### Means for Solving the Problems

An air-operated valve according to the present invention includes: a body provided with a fluid passage; a casing provided above the body; a valve member which opens/closes the fluid passage; a valve rod which moves upward/downward to move the valve member in an open/close direction; a piston provided for the valve rod; and piston driving means which drives the piston by operation air, wherein the casing is made by an upper casing and a lower casing which are screwed in each other, and the piston driving means has a one-touch joint attached to a top part of the upper casing.

The one-touch joint is a known one which fixes a tube by the fastening force of a collet chuck assembled in the body. Since the connection is completed only by inserting the operation air introduction tube into the body, the work of connecting an operation air introduction tube can be performed easily. The user can easily pull out the operation air introduction tube from the one-touch joint by pushing a release bush of the one-touch joint by his/her hand and pulling the operation air introduction tube by the other hand. Even in the case where the operation air introduction tube has to be frequently attached/detached, the attachment/detachment can be performed easily.

The air-operated valve is a valve which opens/closes a fluid passage by driving the piston by the pressure of operation air. Conventionally, a one-touch joint is not incorporated in such a valve. A conventional air-operated valve to which a one-touch joint is attached has a problem that the height increases by the height of the one-touch joint. An air-operated valve with a one-touch joint and an air-operated valve without a one-touch joint have to be properly used. For example, in the case of replacing an air-operated valve without a one-touch joint with an air-operated valve with a one-touch joint, storage or disposal of the detached air-operated valve without a one-touch joint is a problem, so that high compatibility between the valves is demanded.

By incorporating the one-touch joint in the air-operated valve of the present invention, the height of the entire valve is not increased. For example, to replace an air-operated valve without a one-touch joint with an air-operated valve with a one-touch joint, it is sufficient to replace the upper casing with an upper casing having a one-touch joint and detach only the upper casing of the air-operated valve without a one-touch joint. Consequently, storage or disposal of the valve becomes easier. Further, in the case where the one-touch joint projects upward from the valve, when the one-touch joint is subject to impact from the outside during work or the like, there is the possibility that the one-touch joint is broken in a screw part.

Preferably, a through hole is provided in a center part of a top wall of the upper casing. The through hole is made by a small-diameter part on a lower end side, a large-diameter part on an upper end side, and a female screw part having an intermediate diameter provided between the small-diameter part and the large-diameter part. The one-touch joint is inserted in the large-diameter part of the through hole so that a male screw part provided in a lower end part thereof is screwed in the female screw part of the through hole and a release bush provided at an upper end part thereof is exposed. An upper end part of the valve rod is movably inserted in the small-diameter part of the through hole. Preferably, the valve rod has an axial-direction passage extending downward from its upper end and a radial-direction passage extending in a radial direction from the axial-direction passage to the operation air introduction room.

With such a configuration, the height of the air-operated valve with a one-touch joint can be suppressed, and compatibility between an air-operated valve without a one-touch joint and an air-operated valve with a one-touch joint becomes higher.

The number of pistons may be one or plural. As the number of pistons increases, the number of operation air introduction rooms is increased, and the number of radial-direction passages each extending in the radial direction from the axial-direction passage to the operation air introduction room is also increased.

Piston driving means which moves the valve rod upward and downward by making operation air act on the piston may be used. Piston driving means which is used together with an elastic member such as a compression coil spring and moves a valve rod which is energized so as to be always in the open or close position by the elastic member against the energizing force of the elastic member may be also used.

Although the upper and lower sides refer to the upper and lower sides of the drawing (the body side is the lower side, and the casing side is the upper side) in the specification, the “upper and lower sides” are used for convenience. In some cases, the valve is used upside down or transversely.

### Effects of the Invention

In the air-operated valve of the present invention, the casing is made by the upper and lower casings which are screwed in each other, and the piston driving means has the one-touch joint attached to the top part of the upper casing, so that an operation air introduction tube can be connected only by inserting the tube into the body of the one-touch joint, and the tube arrangement work is easy. By using the other parts commonly and changing the upper casing, an air-operated valve with a one-touch joint and an air-operated valve without a one-touch joint can be obtained. Therefore, high compatibility between an air-operated valve with a one-touch joint and an air-operated valve without a one-touch joint can be achieved. With the configuration that the one-touch joint is provided in the valve, the valve does not become too tall, and the device can be miniaturized. Further, by incorporating the one-touch joint on the inside, the one-touch joint is not subject to impact from the outside and can be prevented from being damaged.

### BRIEF DESCRIPTION OF THE DRAWING

FIG. 1 is a vertical sectional view illustrating a closed state of one embodiment of an air-operated valve according to the present invention.

### DESCRIPTION OF REFERENCE NUMERALS

(1): air-operated valve
(2): body
(2a) (2b): fluid passages
(4): casing
(5): diaphragm (valve member)
(8): valve rod
(9) (10): pistons
(9a): shaft part (valve rod upper end part)
(12): piston driving means
(13): one-touch joint
(14): through hole
(14a): small-diameter part
(14b): female screw part
(14c): large-diameter part
(16): release bush
(17): male screw part
(21): lower casing
(22): upper casing

### MODES FOR CARRYING OUT THE INVENTION

An embodiment of the present invention will be described below with reference to the drawings. In the following description, “upper side” and “lower side” refer to the upper side and the lower side, respectively, of the drawing.

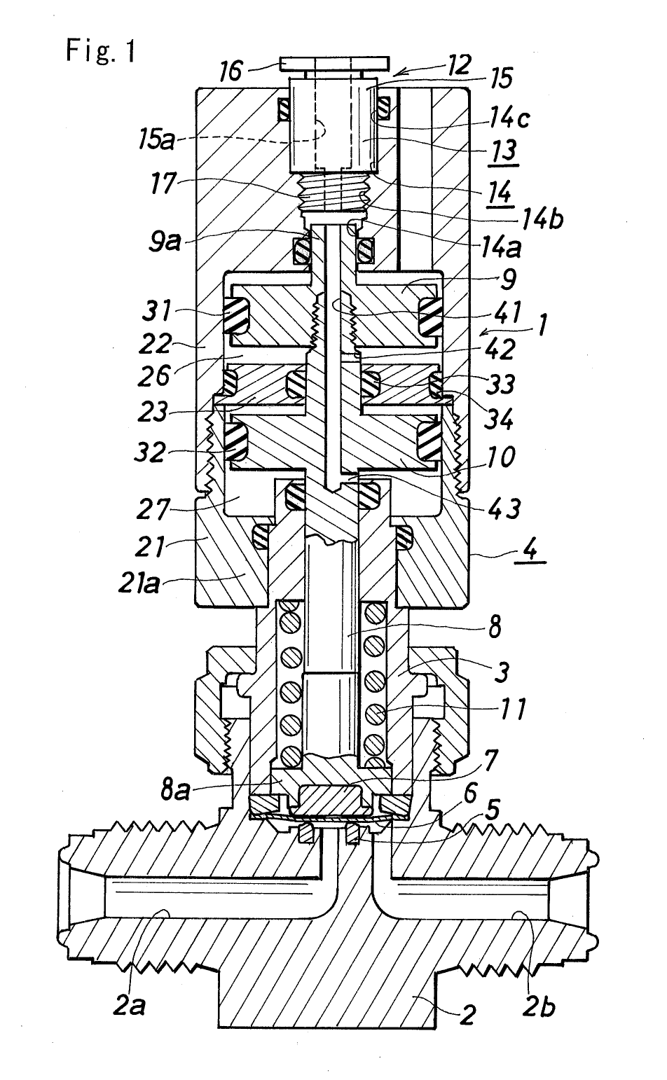

FIG. 1 illustrates one embodiment of an air-operated valve according to the present invention. An air-operated valve (1) includes: a body (2) provided with a fluid inflow passage (2a) and a fluid outflow passage (2b); a casing (4) attached to the top of the body (2) via a hood (3); an annular valve seat (5) attached at the periphery of the fluid inflow passage (2a); a diaphragm (valve member) (6) which is pressed against/is separated from the annular valve seat (5) to close/open the fluid passage (2a); a diaphragm pressing member (7) pressing the diaphragm (6) downward; a valve rod (8) which is disposed in the casing (4) and moves upward/downward to move the diaphragm (6) in an open/close direction; upper and lower pistons (9) and (10) provided for the valve rod (8); a compression coil spring (elastic member) (11) for energizing the valve rod (8) downward; and piston driving means (12) which drives the upper and lower pistons (9) and (10).

The casing (4) is made by a lower casing (21) fixed to the upper end of the hood (3) and an upper casing (22) screwed in the lower casing (21).

The valve rod (8) has, at its lower end, a flange (8a), and the under face of the flange (8a) is in contact with the diaphragm pressing member (7). The lower piston (10) is formed integrally with the valve rod (8). The upper piston (9) is fixed by being screwed in the upper end of the valve rod (8). The upper piston (9) has a shaft (9a) projected upward, and the shaft (9a) corresponds to the upper end of the valve rod (8) (in the specification, the “shaft (9a)” is included in the valve rod (8)).

The piston driving means (12) is provided to make operation air act on each of the pistons (9) and (10) to move the valve rod (8) upward, and an operation air introduction chamber (26) on the upper side and an operation air introduction chamber (27) on the lower side for this purpose are formed below the pistons (9) and (10).

The piston driving means (12) also has a one-touch joint (13) attached to a top part of the upper casing (22).

The one-touch joint (13) has a body (15) incorporating a collet chuck (not illustrated) and a release bush (16) which is provided above the body (15) and releases the collet chuck. Only by inserting an operation air introduction tube in a hollow part (15a) of the body (15), connection of the one-touch joint (13) is completed. At the time of pulling out the operation air introduction tube from the one-touch joint (13), the user can easily pull out the operation air introduction tube by one hand while pushing the release bush (16) by the other hand. Even in the case where the operation air introduction tube has to be frequently attached/detached, the operation air introduction tube can be easily attached/detached.

A counter plate (23) is fixed in the coupling part of the upper and lower casings (22) and (21). A moving space of the upper piston (9) and a moving space of the lower piston (10) are formed on the upper and lower sides of the counter plate (23), respectively. The upper piston (9) is disposed in the upper casing (22) movably in the vertical direction so that its under face is opposed to the upper face of the counter plate (23). The lower piston (10) is disposed in the lower casing (21) movably in the vertical direction so that its top face is opposed to the under face of the counter plate (23).

An O ring (31) is provided between the outer periphery of the upper piston (9) and the upper casing (22), and an O ring (32) is provided between the outer periphery of the lower piston (10) and the lower casing (21). An O ring (33) is provided between the inner periphery of the counter plate (23) and the outer periphery of the valve rod (8), and an O ring (34) is provided between the outer periphery of the counter plate (23) and the upper casing (22). With the configuration, the upper piston (9) is disposed so as to be movable in the vertical direction in the upper casing (22). When operation air is introduced in an upper-side operation air introduction room (26) formed between the upper piston (9) and the counter plate (23), the upper piston (9) receives upward force. The lower piston (10) is disposed so as to be movable in the vertical direction in the lower casing (21). When operation air is introduced in a lower-side operation air introduction room (27) formed between the lower piston (10) and a bottom wall (21a) of the lower casing (21), the lower piston (10) receives upward force.

A through hole (14) is provided in a center part of a top wall of the upper casing (22). The through hole (14) is made by a small-diameter part (14a) on a lower end side, a large-diameter part (14c) on an upper end side, and a female screw part (14b) having an intermediate diameter provided between them. A male screw part (17) provided at a lower end part of the body (15) of the one-touch joint (13) is screwed in the female screw part (14b) of the through hole (14), and the body (15) of the one-touch joint (13) is inserted in the large-diameter part (14c) of the through hole (14) so that the release bush (16) is exposed.

The upper end part of the valve rod (8) (the shaft (9a) formed integrally with the top face of the upper piston (9)) is movably inserted in the small-diameter part (14a) of the through hole (14). In the valve rod (8), an axial-direction passage (41) extending downward from the upper end of the valve rod (8), a radial-direction passage (42) extending from an intermediate part of the axial-direction passage (41) to the upper-side operation air introduction room (26), and a radial-direction passage (43) extending from the lower end of the axial-direction passage (41) to the lower-side operation air introduction room (27) are formed. The upper end opening of the axial-direction passage (41) of the valve rod (8) faces the lower end opening of the one-touch joint (13). With the configuration, the operation air flows in the operation air introduction rooms (26) and (27) via the one-touch joint (13).

In a state where the operation air is not introduced in the operation air introduction rooms (26) and (27), the valve rod (8) is in a closed position (lower position) by the energization force of the compression coil spring (11). When the operation air is introduced in the operation air introduction rooms (26) and (27), the valve rod (8) is moved upward against the energization force of the compression coil spring (11), the open state is obtained.

The air-operated valve (1) can be obtained by replacing an upper casing of an air-operated valve incorporating no one-touch joint (13) with the above-described upper casing (22) (the upper casing (22) to which the one-touch joint (13) is attached). Compatibility between the air-operated valve with the one-touch joint and the air-operated valve without the one-touch joint is high. With the configuration that the one-touch joint (13) is incorporated in the air-operated valve, the air-operated valve does not become too tall, and the device can be miniaturized. By incorporating the one-touch joint (13), the one-touch joint (13) is not subject to impact from the outside and can be prevented from being damaged.

### INDUSTRIAL APPLICABILITY

According to the present invention, the air-operated valve suitable for use in a form using a one-touch joint, with improved easiness of a tube arrangement work, compatibility between an air-operated valve with a one-touch joint and an air-operated valve without a one-touch joint, miniaturization of the device, prevention of damaging in a one-touch joint, and the like is obtained. Consequently, the invention can contribute to improve the performance of the air-operated valve.

1. An air-operated valve comprising:
a body provided with a fluid passage;
a casing provided above the body;
a valve member which opens/closes the fluid passage;
a valve rod which moves upward/downward to move the valve member in an open/close direction;
a piston provided for the valve rod; and
piston driving means which drives the piston by operation air,
wherein the casing is made by an upper casing and a lower casing which are screwed in each other, and the piston driving means has a one-touch joint attached to a top part of the upper casing.

2. The air-operated valve according to claim 1, wherein a through hole is provided in a center part of a top wall of the upper casing,
the through hole is made by a small-diameter part on a lower end side, a large-diameter part on an upper end side, and a female screw part having an intermediate diameter provided between the small-diameter part and the large-diameter part,
the one-touch joint is inserted in the large-diameter part of the through hole so that a male screw part provided in a lower end part thereof is screwed in the female screw part of the through hole and a release bush provided at an upper end part thereof is exposed,
and an upper end part of the valve rod is movably inserted in the small-diameter part of the through hole.
